(19) United States
(12) Patent Application Publication
(10) Pub. No.: US 2007/0136340 A1
(43) Pub. Date: Jun. 14, 2007

(54) Document and file indexing system

(76) Inventor: Mark Radulovich, Houston, TX (US)

Correspondence Address: WONG, CABELLO, LUTSCH, RUTHERFORD & BRUCCULERI LLP, 20333 SH 249, SUITE 600, HOUSTON, TX, 77070, US

(21) Appl. No.: 11/301,341

(22) Filed: Dec. 12, 2005

(51) Int. Cl. G06F 7/00

(52) U.S. Cl. 707/101

(57) ABSTRACT

A computer system where portions of the indexing application are inserted between the user application and the disk write processing software so that the indexing information for the particular document being stored is obtained as the document is being stored. In a separate parallel operation this document indexing information is provided to the main search index for incorporation. In various embodiments the document and the index can be compressed and encrypted if desired for transmission to a remote computer. The document and the index can be stored locally or remotely, or in any combination. The document or file and the index can be cached locally, if they are stored remotely and the local and remote computers are not in communication. The indexing operations occur on copying operations as well as the writing of modified or new files.

### BACKGROUND OF THE INVENTION

1. Field of the Invention

This invention relates to indexing of computer files.

2. Review of the Related Art

With the vast number of computerized documents being created, it is becoming extremely difficult to actually find a particular document. While we are beyond the days of 8.3 file names, even the use of long file names has not solved the problem. To address this, various indexing applications have been developed. Referring to FIG. 1, a typical indexing application is shown. An operating system 100 is present on the computer system. Connected to the operating system is disk storage 102. The operating system 100 also contains disk write processing software 104, generally part of the operating system itself and part of the disk driver stack. A user application 106 is connected to this disk write processing software 104 when the user application 106 needs to write a document or file to the disk 102. This is done in conventional operations in the prior art. The user application 106 simply provides the file to the disk write processing software 104, which then provides the file to the disk 102. An indexing application 108 is running in the background and periodically checks the file tables of the disk 102 to see if new or modified files have been written to the disk 102. If so, then the indexing application 108 reads the files from the disk 102, processes them to parse the information to create an index, retrieves the existing index from the disk 102, merges the new index entries into the existing index and then stores the existing index back onto the disk 102 using the disk write processing software 104. Because the index contains all of the contents of the file, the use of indexes has greatly improved the capability to find materials in the various documents. However, this is a non-real-time operation so that various information that has been recently written to the disk 102 is not available.

FIG. 2 provides a flowchart illustration of this operation. In step 199 the indexing application 108 determines if there are any recently modified or added files. In step 200 the indexing application 108 opens the document which has been recently added or modified. In step 202 the indexing application 108 parses the document data to create a document index. In step 204 the metadata of the document or file is added to the index, such as document name, size and so on. In step 206 the main search index, which resides generally on the disk 102, is retrieved and updated with the document index data. In step 208 a delay is inserted to have the indexing application 108 wait a predetermined amount of time until it looks again and returns to step 199 to determine if there are any more recently modified or added files.

In addition to not keeping the main search index current, numerous read operations are required, thus slowing down overall operations. This has been alleviated to some extent by performing the activities only when the computer is otherwise unused, but this requires additional logic to track use of the computer and does hinder performance when the computer starts being used when the indexing activities are occurring.

It would be desirable to be able to perform real time processing of the index without requiring additional read operations and otherwise noticeably slowing down computer operations.

### BRIEF SUMMARY OF THE INVENTION

In the computer system according to the present invention, portions of the indexing application are inserted between the user application and the disk write processing software so that the indexing information for the particular document being stored is obtained as the document is being stored. In a separate parallel operation this document indexing information is provided to the main search index for incorporation. The act of determining the document index information and updating the main search index are done independently so that index data can be readily determined as the document is stored, avoiding the need to read the documents to develop the index values.

In various embodiments the document and the index can be compressed and encrypted if desired for transmission to a remote computer. The document and the index can be stored locally or remotely, or in any combination. The document or file and the index can be cached locally, if they are stored remotely and the local and remote computers are not in communication. The indexing operations occur on copying operations as well as the writing of modified or new files in the preferred embodiments.

### BRIEF DESCRIPTION OF THE FIGURES

FIG. 1 is a block diagram of indexing according to the prior art.

FIG. 2 is a flowchart of indexing operations according to the prior art.

FIG. 3 is a block diagram of a first embodiment of indexing according to the present invention.

FIG. 4 is a block diagram of a second embodiment of indexing according to the present invention.

FIG. 5 is a block diagram of a third embodiment of indexing according to the present invention.

FIG. 6 is a flowchart of operations of a first embodiment according to the present invention.

FIG. 7 is a flowchart of operations of a second embodiment according to the present invention.

FIG. 8 is a flowchart of operations of a third embodiment according to the present invention.

FIG. 9 is a flowchart of a fourth embodiment according to the present invention.

FIG. 10 is a flowchart of a first copy embodiment according to the present invention.

FIG. 11 is a flowchart of a second copy embodiment according to the present invention.

FIG. 12 is a flowchart of a third copy embodiment according to the present invention.

FIG. 13 is a flowchart of a fourth copy embodiment according to the present invention.

### DETAILED DESCRIPTION OF THE PREFERRED EMBODIMENTS

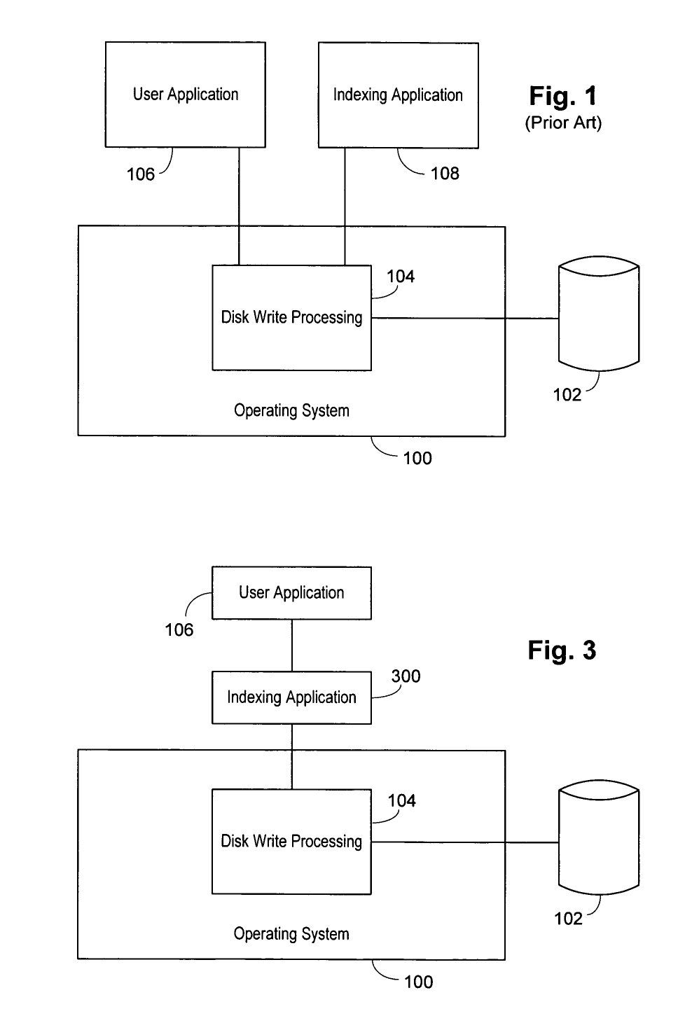

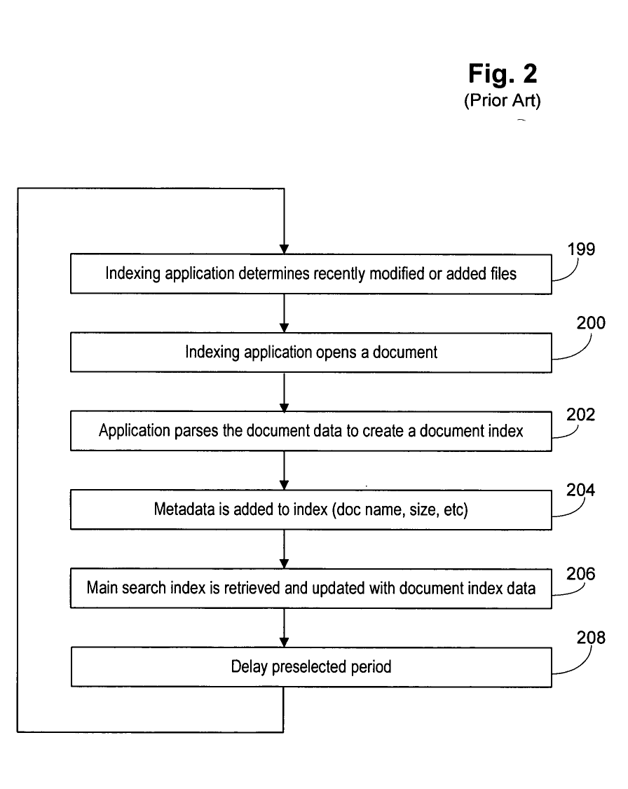

Referring then to FIG. 3, like numbered elements as in FIG. 1 are numbered the same. In the embodiment of FIG. 3 an indexing application 300 has been incorporated between the user application 106 and the disk write processing software 104. In this manner the indexing application 300 has access to the document or file being stored prior to the operating system 100 and thus is in line and performs its operations in that manner.

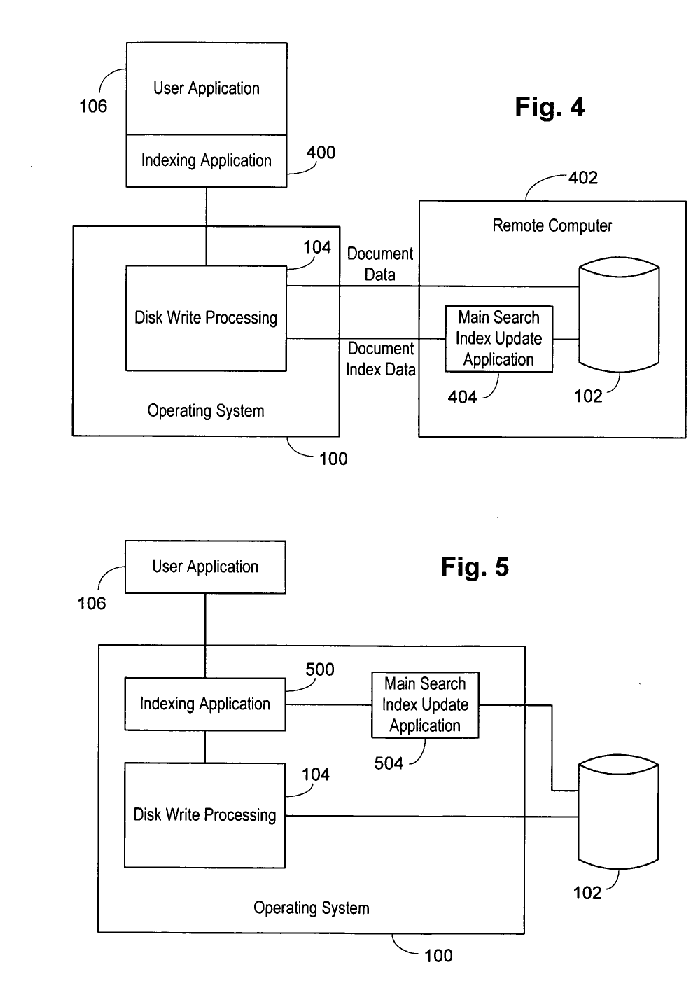

FIG. 4 is an alternative where the indexing application is merged or made as an add-on or incorporated into the user application 106. Thus the user application 106 actually invokes the indexing application 400 to communicate with the disk write processing 104. FIG. 4 also provides exemplary details of the remote computer 402 in embodiments where the main search index and/or documents and files are stored remotely. In this example the remote computer 402 includes the disk drive 102. There is a first path directly from the write processing software 104 to the disk drive 102 for storage of the documents or files themselves. A main search index update application 404 is present between the write processing software 104 and the disk drive 102 for the document index data. The main search index update application 404 receives the individual document index data and merges it with the remainder of the main search index which is stored on the disk drive 102. Thus, in the case of remote index storage, the updating of the main search index is done by a separate computer, thus further reducing processing demands on the local computer.

In the embodiment of FIG. 5, the indexing application 500 has been moved and made a part of the operating system and is the entry point accessed by the user application 106 in writing files. In this exemplary embodiment the main search index update application 504 is located locally, so that the document and main search index are all stored locally. The main search index update application 504 is then connected between indexing application 500 and the disk drive 102 to allow it to directly receive the document index data.

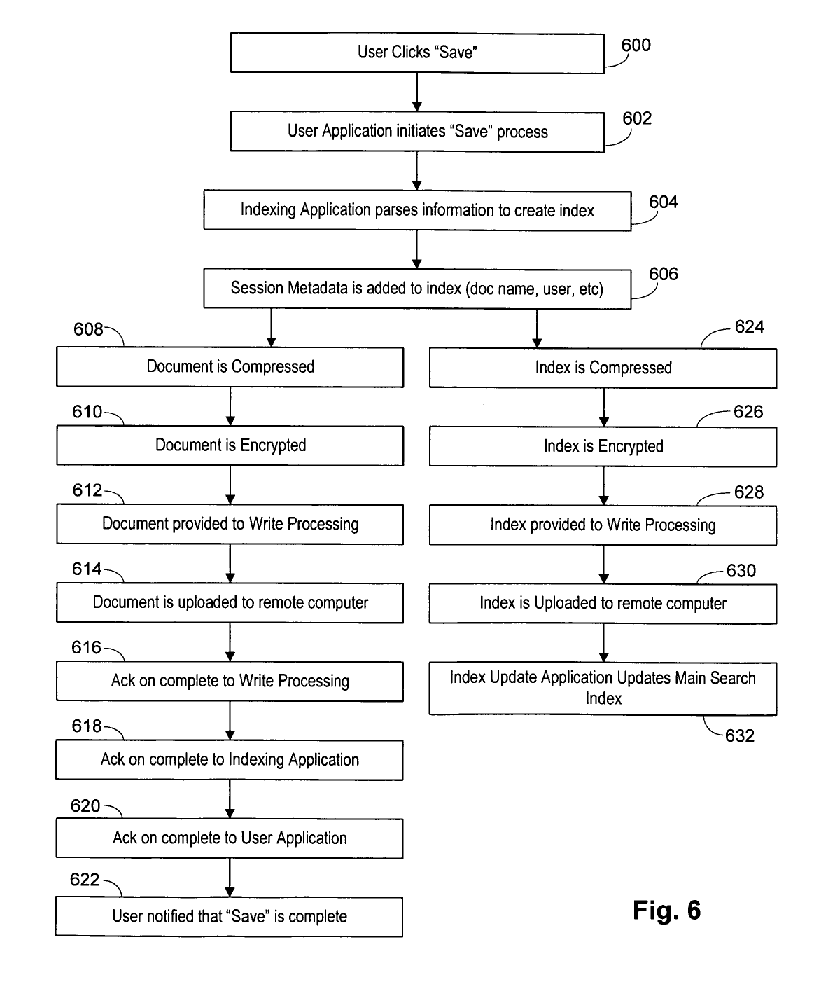

Referring then to FIG. 6, flowchart operations according to a first embodiment of the present invention are shown. In this first embodiment in step 600 the user clicks SAVE to save the particular document. In step 602 the user application 106 initiates the SAVE process. This entails, in the first embodiment, passing the document to the indexing application 308, 400 or 500. Then in step 604 the indexing application 308, 400 or 500 parses the information present in the particular document to create a document index. In step 606 session metadata is added to this document index that has been created. The session metadata includes information such as the document name, the user, and so on. Following step 606, two parallel operations are commenced. In the first series of operations, in step 608 the document is compressed. In step 610 the compressed document is then encrypted. This is done because in this particular embodiment the documents and the main search index are stored remotely, as shown in FIG. 4 for example, and are communicated with over the Internet or other network so that compression and encryption may be necessary to preserve (1) confidential material and (2) limit the amount of data actually being transferred. In step 612 the compressed, encrypted document is then provided to the write processing software 104 for its normal operations. In this embodiment where the local computer is actually connected to the remote computer such as 402, the document in step 614 is then uploaded to the remote computer 402 by the write processing software 104, with the remote computer 402 alternatively decrypting and decompressing the document for storage or storing the document in encrypted and compressed format to maintain security and save space. In step 616 the remote computer 402 has completed the write operation and an acknowledge is provided to the write processing software 104. The write processing software 104 then in step 618 provides an acknowledge to the indexing application 308, 400, or 500, which in step 620 then passes this acknowledge on to the user application 106. Therefore in step 622 the user is notified that the SAVE operation is complete.

Running in parallel with this are the index transfer operations. In step 624 the document index information is compressed and in step 626 it is encrypted. It is understood that these compression and encryption operations may occur in any of the embodiments and are fully described in this first embodiment and omitted from other embodiments for clarity. In step 628, after the document index data has been encrypted, it is provided to the write processing software 104 and then uploaded in step 630 to the remote computer 402. In step 632 the main search index application 404 decrypts and decompresses the document index information, if necessary, and updates the main search index to include this information from this particular document.

The operations of steps 604 and 606 to obtain the local document index data and to provide the additional metadata for a single document are very quick operations which will not be noticeable to the particular user in the saving process. As the main search index incorporation is then performed in a parallel operation by a separate remote computer 402, the main search index can be updated much more easily and the local computer is not required to perform that potentially burdensome operation.

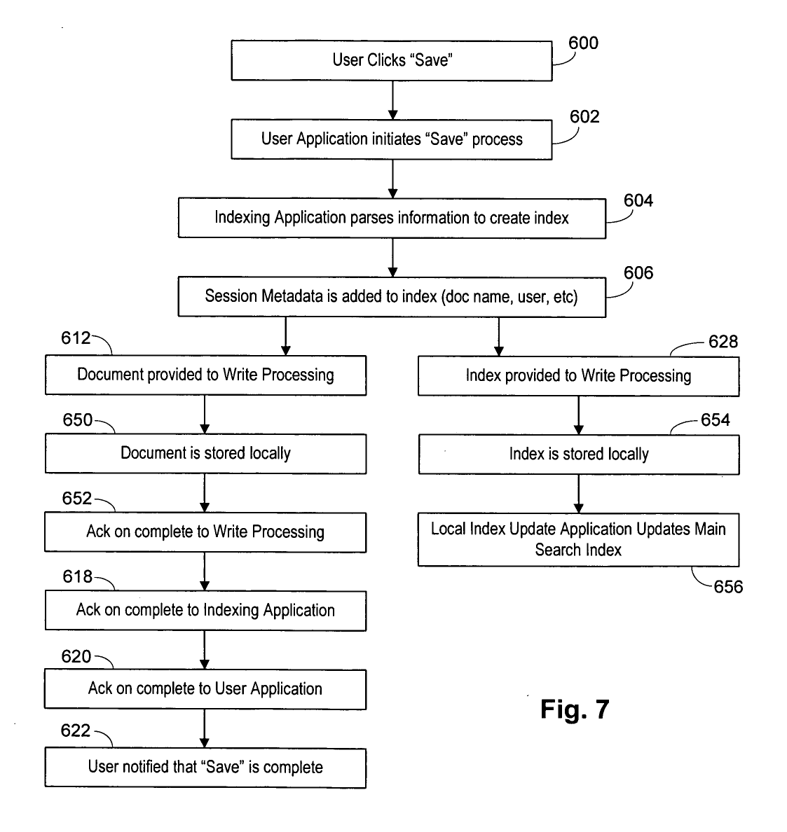

FIG. 7 is a similar embodiment except in this case the document is saved locally instead of remotely and the main search index is also stored locally as in FIG. 5. Thus after step 612 the write processing software 104 saves the document locally in step 650, again in uncompressed, unencrypted format or in compressed, encrypted format. In step 652 this local operation then provides the acknowledge to the write processing software 104. In the index flow, in step 654 the index data is stored locally for use by the main search index update application 504. Then in step 656 the main search index update application 504 updates the main search index.

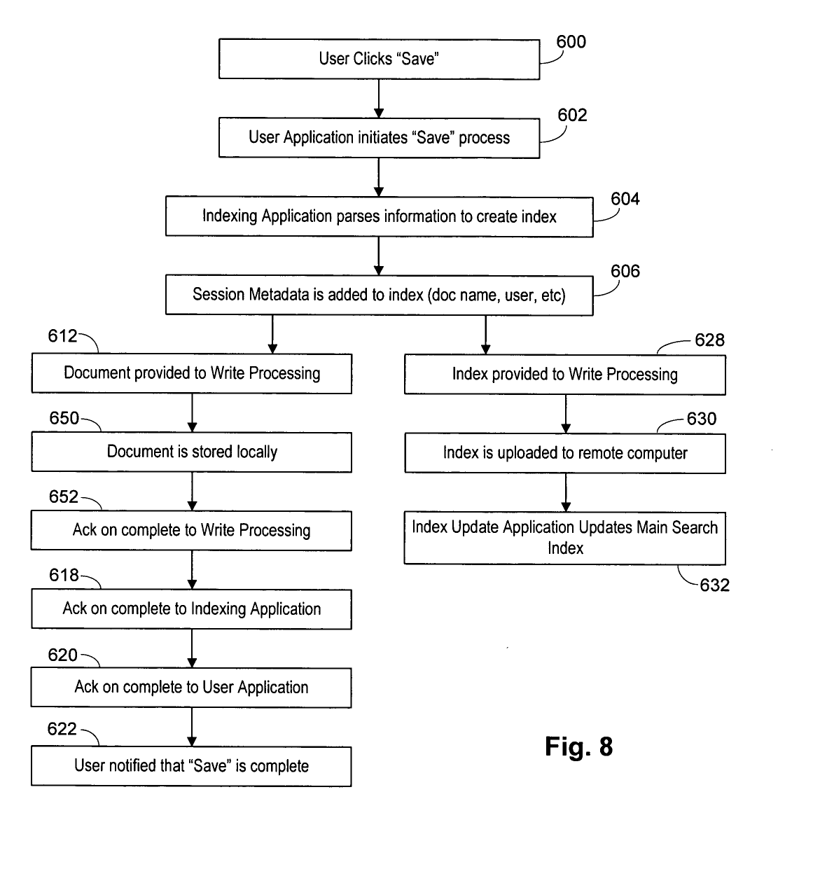

FIG. 8 is a slight alternative to FIG. 7 in that while the document itself is stored locally, the document index data is provided to a remote computer 402 in step 630, which then again in step 632 updates the main search index. The advantages of having the index updating performed by a server dedicated to that function and not utilizing local processing resources is present in this embodiment as well. Further, this local document storage but remote main search index storage allows a transparency between local and remotely stored documents when operations according to FIG. 6 and FIG. 8 are combined. The main search index contains a full index, whether the document is local or remotely stored, thus providing the most complete capabilities.

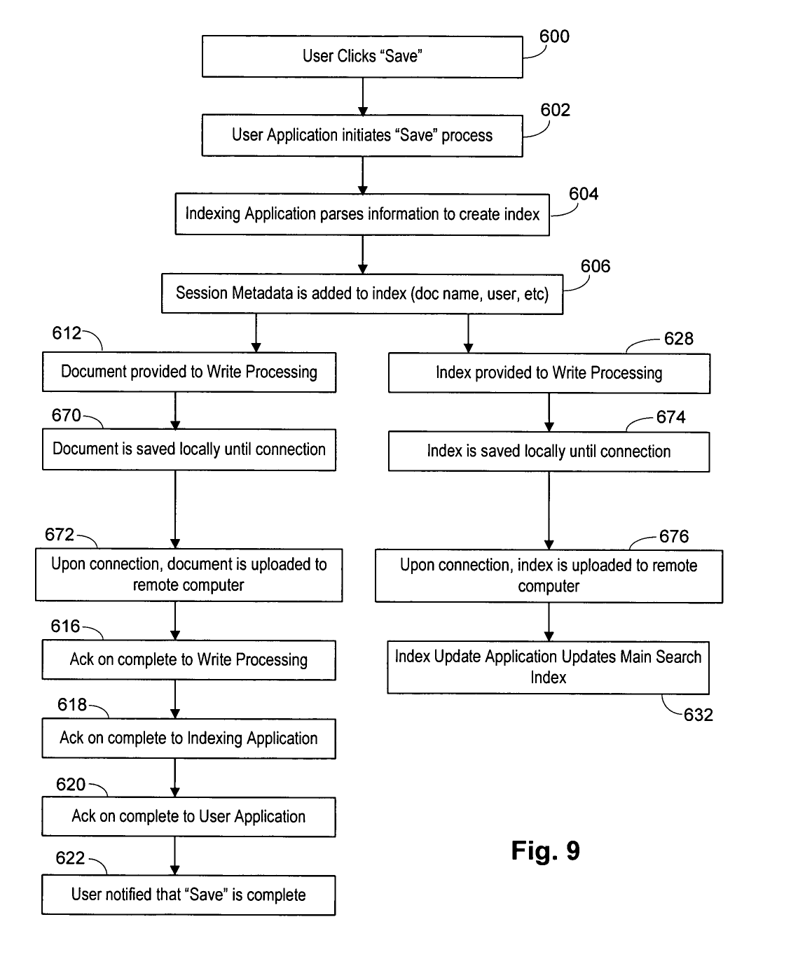

FIG. 9 is a variation of FIG. 6 except that the local computer is not initially connected to the remote computer when the document is saved and yet that is where the document and the document index data are to be stored. Thus in step 670, which occurs after step 612, the document is saved or cached locally until the local computer is connected to the remote computer 402. Then upon connection in step 672 the document is uploaded to the remote computer 402. Operations then proceed as normal in step 616. Similarly for the index path, after the index is provided to the write processing software 104, in step 674 the document index data is saved locally, i.e., cached, until the local unit is connected to the remote computer 402. In step 676, upon connection, the document index data is uploaded to the remote computer 402, which then performs its normal operations in step 632.

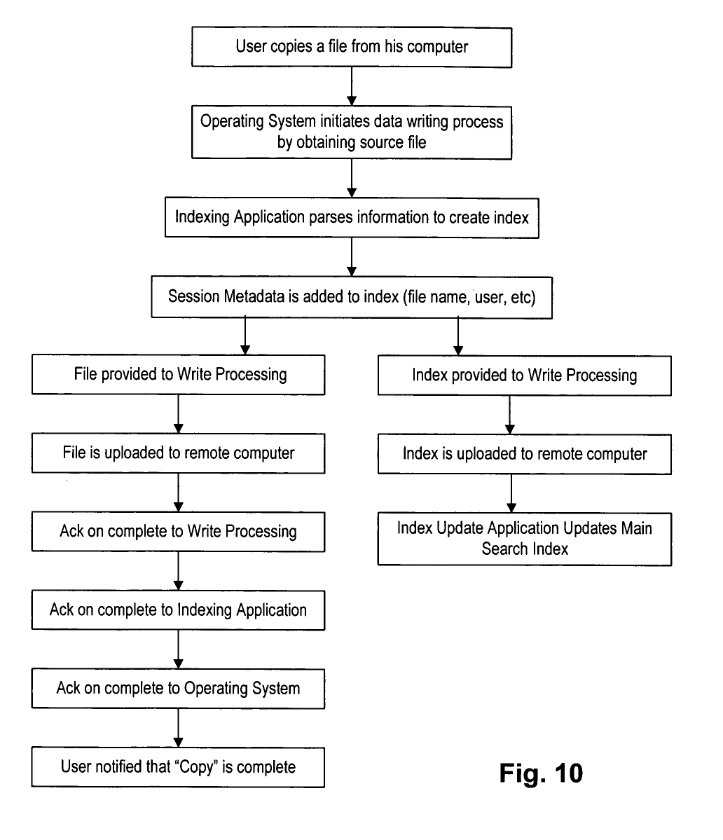

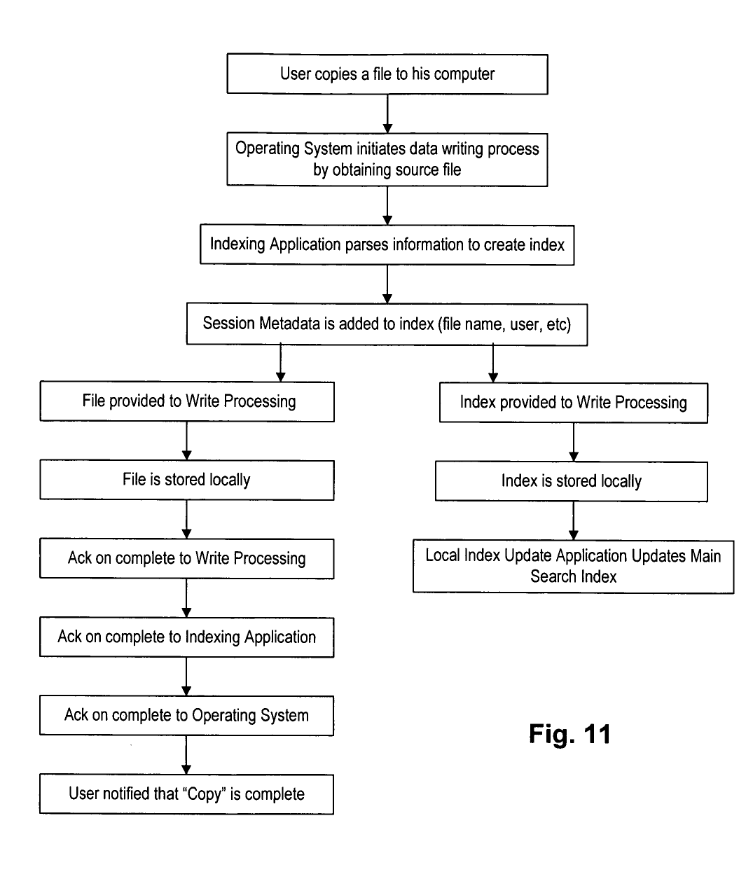

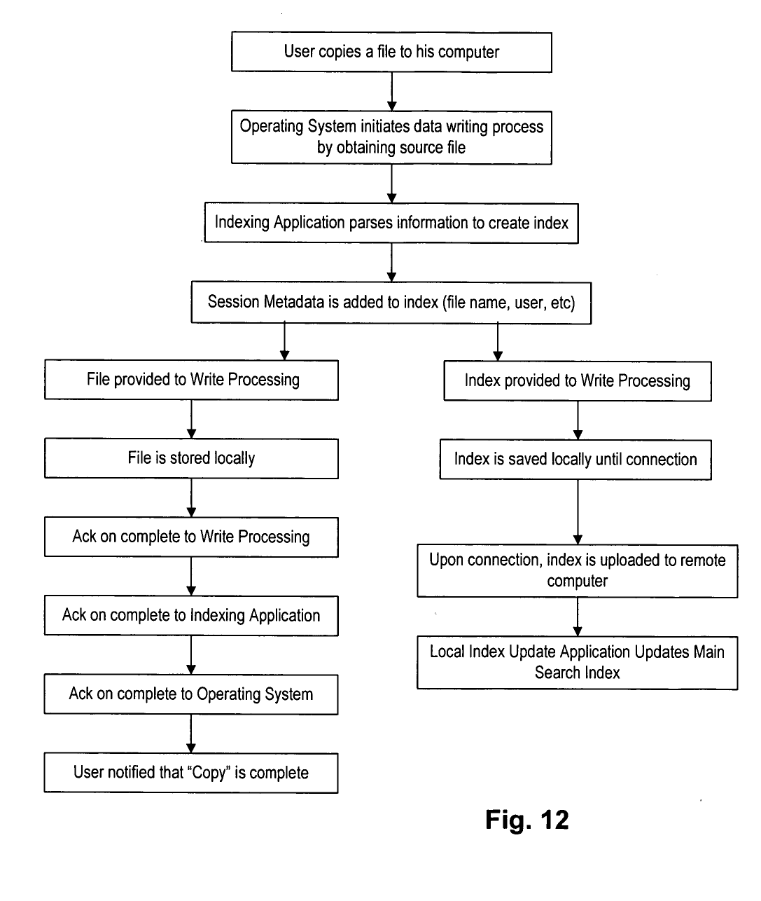

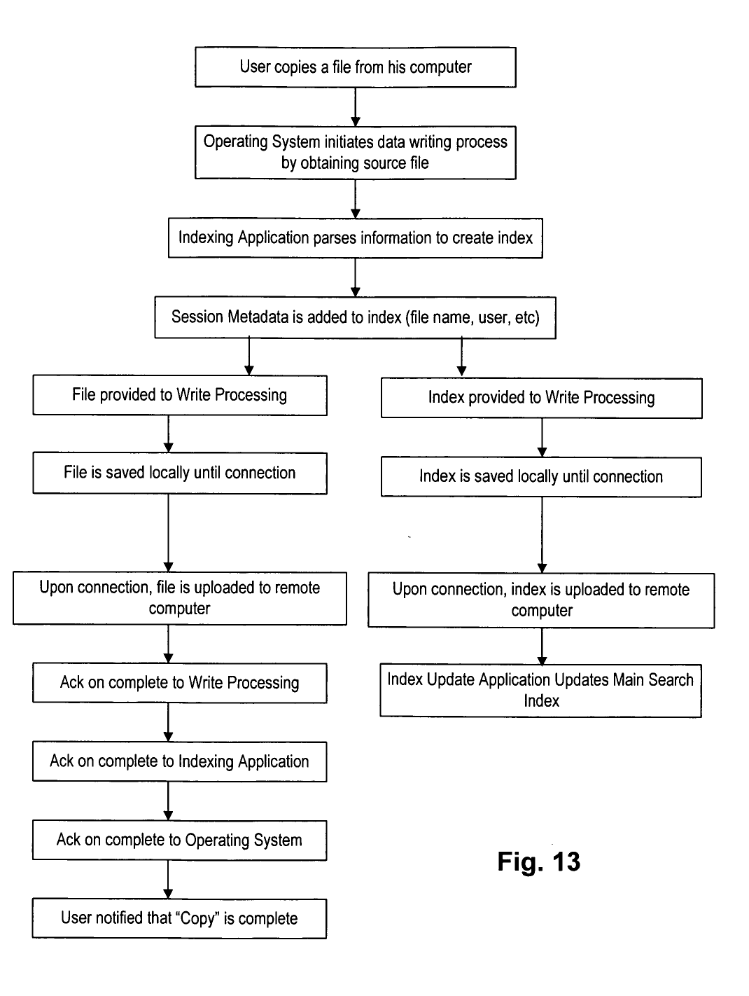

FIGS. 10-13 are equivalent to FIGS. 6-9 except they are for file copy operations to or from the local computer instead of being documents saved from a user application such as a word processor. Thus the operating system in a copy operation initiates the data writing rather than the user application. In all other aspects the operations are essentially similar. Therefore detailed explanations are not provided for those figures.

One interesting variation that can be done in the case of the files and main search index being stored on the remote computer is that various indices can be developed which are then shared by selected individuals. In a shared environment there are various permission groups that have access to selected sets of files. If the particular file is written into a folder with shared rights, this information can be included in the metadata and then would be incorporated into the main search index itself by the index update application. Then, whenever a particular individual elects to do an index search operation, the search would cover all of the accessible files, including those in shared folders as well as that individual's personal files. However, if the individual did not have rights to the particular folder, then files in that folder would be excluded from the search results. This incorporation of folder permissions and rights into the metadata allows more complete indexing of available information.

While a single remote computer and disk drive has been illustrated, it is understood that multiple computers could be used and the file storage and index operations performed on separate computers and to separate disk drives.

It is further understood that while selected combinations of local and remote file and index storage have been shown, other variations can readily be developed using the disclosed principles.

It will be understood from the foregoing description that modifications and changes may be made in various embodiments of the present invention without departing from its true spirit. The descriptions in this specification are for purposes of illustration only and are not to be construed in a limiting sense. The scope of the present invention is limited only by the language of the following claims.

What is claimed is:

1. A method for indexing data comprising:
receiving a request at a local computer to write a file to a storage medium;
parsing the file to develop single file index information after receiving the write request;
writing the file to the storage medium after parsing the file; and
merging the single file index information developed from parsing the file into a main index containing information on a plurality of files.

2. The method of claim 1, wherein the parsing step includes adding metadata about the file to the single file index information.

3. The method of claim 1, wherein the file writing step is performed by a module of an operating system.

4. The method of claim 3, wherein the parsing step is performed by a module of an operating system.

5. The method of claim 3, wherein the request to write a file is provided by a user application and the parsing step is performed by a module independent of the user application and the operating system.

6. The method of claim 3, wherein the request to write a file is provided by a user application and the parsing step is performed by a module associated with the user application.

7. The method of claim 1, wherein the storage medium is located in either a local computer or a remote computer and the main index is located in either a local computer or a remote computer.

8. The method of claim 7, wherein if a remote computer is utilized, transfers to the remote computer are encrypted and compressed.

9. The method of claim 8, wherein if a remote computer is utilized and the local computer cannot communicate with the remote computer, the data from operation is temporarily stored on the local computer.

10. The method of claim 1, wherein a plurality of users can access the storage medium and the main index, with stored files accessible by different sets of the plurality users, wherein the main index contains information on all of the stored files and wherein search results provided to a user from the main index includes only files accessible to that user.

11. The method of claim 1, wherein the file is stored in encrypted and/or compressed form.

12. A computer readable medium having computer-executable instructions for performing a method comprising:
receiving a request to write a file to a storage medium;
parsing the file to develop single file index information;
directing the writing of the file to the storage medium after parsing the file; and
providing the single file index information to a main indexing module.

13. The medium of claim 12, the method further comprising:
executing the main indexing module to merge the single file index information into a main index containing information on a plurality of files.

14. The medium of claim 12, wherein the parsing step includes adding metadata about the file to the single file index information.
